(19) United States
(12) Patent Application Publication
(10) Pub. No.: US 2009/0058384 A1
(43) Pub. Date: Mar. 5, 2009

(54) REFERENCE VOLTAGE GENERATING CIRCUIT AND TIMER CIRCUIT

(75) Inventor: Kazutaka Taniguchi, Kawasaki-shi (JP)

Correspondence Address: YOUNG & THOMPSON, 209 Madison Street, Suite 500, ALEXANDRIA, VA, 22314, US

(73) Assignee: NEC ELECTRONICS CORPORATION, KANAGAWA (JP)

(21) Appl. No.: 12/200,351

(22) Filed: Aug. 28, 2008

(30) Foreign Application Priority Data
Aug. 28, 2007 (JP) 2007-220519

(51) Int. Cl. G05F 1/10; G05F 1/00

(52) U.S. Cl. 323/282; 323/234; 323/293

(57) ABSTRACT

A reference voltage generating circuit includes a constant current source circuit connected with a power supply voltage and configured to output a reference current to an output node based on the power supply voltage. A current-voltage converting circuit is connected the output node and generates a reference voltage to the output node based on the reference current. A first voltage adjusting circuit is connected with the output node and is configured to adjust dependence of the reference voltage on the power supply voltage in a positive direction. A second voltage adjusting circuit is connected with the output node and is configured to adjust dependence of the reference voltage on the power supply voltage in a negative direction.

### INCORPORATION BY REFERENCE

This application claims a priority on convention based on Japanese Patent Application No. 2007-220519 filed on Aug. 28, 2007. The disclosure thereof is incorporated herein by reference.

### BACKGROUND OF THE INVENTION

1. Field of the Invention

The present invention relates to a reference voltage generating circuit, and more particularly, to a reference voltage generating circuit capable of freely controlling voltage dependence on a power supply voltage.

2. Description of Related Art

A reference voltage generating circuit outputs a constant voltage having no voltage dependence on an input voltage (power supply voltage). In accompaniment with recent miniaturization of a circuit, it has become difficult to completely eliminate the dependence of an output voltage (hereinafter to be also referred to as a reference voltage) on the power supply voltage in the reference voltage generating circuit.

FIG. 1 is a circuit diagram illustrating a configuration of a conventional reference voltage generating circuit. This circuit is generally referred to as a bandgap reference circuit, and widely known. In FIG. 1, the reference voltage generating circuit includes P-channel field effect transistors (hereinafter, to be referred to as PMOS transistors) P101, P102, and P103, N-channel field effect transistors (hereinafter to be referred to as NMOS transistors) N101 and N102; a diode element D101; and resistance elements R101 and R102. In the circuit, a constant voltage is outputted from a higher potential side power supply voltage Vcc and a lower potential side power supply voltage GND to a reference voltage terminal BGR. In the reference voltage generating circuit, a source of the PMOS transistor P101 is connected to Vcc. Also, a drain and gate of the NMOS transistor N101 are connected to a drain of the PMOS transistor P101, and a source of the NMOS transistor N101 is connected to the ground voltage GND. Further, a source of the PMOS transistor P102 is connected to the power supply Vcc, and a drain and gate thereof are connected to a gate of the PMOS transistor P101. Still further, a drain of the NMOS transistor N102 is connected to a gate of the PMOS transistor P103, and a gate of the NMOS transistor N102 is connected to the gate of the NMOS transistor N101. Also, the resistance element R101 is connected between a source of the NMOS transistor N102, and the ground voltage GND. Further, a source of the PMOS transistor P103 is connected to Vcc, the gate of the PMOS transistor P103 is connected to the gate of the PMOS transistor P102, and a drain of the PMOS transistor P103 is connected to the reference voltage terminal BGR. Still further, the resistance element R102 is connected to the drain of the PMOS transistor P103. Yet further, the diode D101 is connected to the resistance element R102 at an anode thereof, and to the ground voltage GND at a cathode thereof.

In FIG. 1, a current i101 flows through the PMOS transistor P101 and the NMOS transistor N101, a current i102 flows through the PMOS transistor P102 and the NMOS transistor N102; and a current i103 flows through the PMOS transistor P103. Also, it is assumed that gate lengths of the PMOS transistors P101, P102, and P103 are same and the gate widths thereof are same. The NMOS transistor N102 has a same gate length as that of the NMOS transistor N101 and a gate width M (M>0) times larger than that of the NMOS transistor N102. Here, it is assumed that q is electron charge, VF_{D1} is a forward direction voltage of the diode D101, k is the Boltzmann constant, and T is the absolute temperature. In this case, the reference voltage Vbgr at the reference voltage terminal BGR is ideally expressed by the following equation (1), and consequently a constant voltage independent of the power supply voltage can be obtained:

Vbgr=R102/R101×(kT/q)×ln(M)+VF_{D1} (1)

However, in a reference voltage generating circuit illustrated in FIG. 1, transistors are used. The transistor may give rise to the early effect depending on characteristics thereof. In the circuit of FIG. 1, if the early effects arise in the PMOS transistors P101 and P103, and the NMOS transistor N102, the reference voltage may vary relative to the power supply voltage. It should be noted that the early effect is a phenomenon in which, when a voltage between a source and a drain of a transistor is increased, a drain current is increased. FIGS. 2A and 2B are graphs illustrating voltage-current characteristics in a weak inversion region of the transistor. FIG. 2A illustrates the characteristic in case that the early effect is absent, whereas FIG. 2B illustrates the characteristic in case that the early effect is present. As illustrated in FIG. 2A, when the early effect is absent, a source-drain current (IDS) of the transistor is almost constant in the weak inversion region, independently of a source-drain voltage (VDS). On the other hand, as illustrated in FIG. 2B, when the early effect is present, the source-drain current (IDS) of the transistor is increased in the weak inversion region as the source-drain voltage (VDS) of the transistor is increased.

A situation when the early effect arises in the reference voltage generating circuit of FIG. 1 will be described. It is assumed that, due to increase in a voltage difference between the power supply voltages Vcc and the ground voltage GND, a source-drain voltage of the PMOS transistor P101 is increased, so that the early effect arises. As a result, the current i101 flowing through the NMOS transistor N101 is increased. This also causes increase in the drain current of the NMOS transistor N102 to the NMOS transistor N101 arranged in a current mirror circuit. The current i102 flowing through the NMOS transistor N102 is increased by an amount corresponding to the current increase in the NMOS transistor N101 along with a current increase due to the early effect in the NMOS transistor N102. This also causes the increase in the drain current of the PMOS transistor P102. Accordingly, the drain current i103 of the PMOS transistor P103 has a current mirror configuration with the PMOS transistor P102 is also increased. As a result, the reference voltage is varied. Specifically, given that the current increases due to the early effects in the PMOS transistor P101 and the NMOS transistor N102 are Δid1 and Δid2, the drain current increase due to the early effect in the PMOS transistor P103 by Δid3. The increase Δid3 is expressed by the following equation (2).

Δid3=Δid1+Δid2 (2)

The current increase Δid3 flows through the resistance element R102 and the diode element D101 to thereby vary the reference voltage Vbgr. Given that the variation in the reference voltage is denoted by ΔVbgr, the drain current of the PMOS transistor P103 prior to the effect of the voltage variation is denoted by IDS(P103), ΔVbgr is expressed by the following equation (3).

ΔVbgr=Δid3×R102+(kT/q)×ln((Δid3+IDS(P103))/IDS(P103) (3)

A technique for suppressing such reference voltage variation due to the early effect is described in Japanese Patent Application Publication (JP-P2002-99336A). FIG. 3 is a circuit diagram illustrating a configuration of a reference voltage generating circuit in the publication. In the reference voltage generating circuit, an NMOS transistor N111 is added to the reference voltage generating circuit illustrated in FIG. 1. A drain of the NMOS transistor N111 is connected to that of the PMOS transistor P102; a source of the NMOS transistor N111 is connected to the NMOS transistor N102; and a gate of the NMOS transistor N111 is connected to the reference voltage terminal BGR. Such a configuration allows an increase in the drain current of the PMOS transistor P102 to be suppressed, because the drain voltage of the NMOS transistor N102 is fixed to a voltage lower by a gate-source voltage of the NMOS transistor N111 than the original drain voltage even if the voltage between the power supply voltages Vcc and the ground voltage GND is increased. This also suppresses the increase in the drain current of the PMOS transistor P103, and Δid3 in the above equation (2) is decreased without being affected by the early effect. Accordingly, ΔVbgr in the equation (3) is decreased, and therefore Vbgr having less voltage dependence can be generated.

By the way, in recent years, the reference voltage generating circuit is applied to various application fields such as a semiconductor storage device. In accompaniment with this, requirements to the reference voltage generating circuit are also increasing. One of such requirements is to make the reference voltage depend on the power supply voltage to control the reference voltage. To respond to such a requirement, the reference voltage generating circuit is required to have dependence on the power supply voltage.

Japanese Patent Application Publication (JP-A-Heisei 5-119860) discloses a technique in which the reference voltage has the dependence on the power supply voltage. In this conventional technique, a reference voltage generating circuit is provided in which the reference voltage is changed linearly in accordance with the power supply voltage.

Also, as a related art, Japanese Patent Application Publication (JP-P2005-78510A) describes a current source circuit having negative dependence on a power supply voltage. The current source circuit is provided with a first circuit for generating a first current having positive dependence on the power supply voltage; a second circuit for generating a second current having larger positive dependence on the power supply voltage than that of the first current; and a third circuit for generating a third current having negative dependence on the power supply voltage by subtracting the second current from the first current.

As already described, there is a requirement of the reference voltage generating circuit having the reference voltage depending on the power supply voltage. More specifically, it may be required that the reference voltage can be controlled to have positive voltage dependence on the power supply voltage in some cases, whereas it can be controlled to have the negative voltage dependence on the power supply voltage in other cases.

The technique described in Japanese Patent Application Publication (JP-P2002-99336A) is for outputting a constant reference voltage independently of the power supply voltage, and cannot freely control the reference voltage. Also, according to Japanese Patent Application Publication (JP-A-Heisei 5-119860), the reference voltage has positive dependence on the power supply voltage, but cannot control the voltage dependence of the reference voltage so as to have negative dependence. Further, according to Japanese Patent Application Publication (JP-P2005-785106A), it is described that a current having negative dependence on the power voltage is generated. However, the power supply voltage dependence of the reference voltage cannot be freely controlled in a positive or negative direction.

### SUMMARY

In an aspect of the present invention, a reference voltage generating circuit includes a constant current source circuit connected with a power supply voltage and configured to output a reference current to an output node based on the power supply voltage; a current-voltage converting circuit connected the output node and configured to generate a reference voltage to the output node based on the reference current; a first voltage adjusting circuit connected with the output node and configured to adjust dependence of the reference voltage on the power supply voltage in a positive direction; and a second voltage adjusting circuit connected with the output node and configured to adjust dependence of the reference voltage on the power supply voltage in a negative direction.

In another aspect of the present invention, a timer circuit includes a reference voltage generating circuit configured to output a reference voltage; and a ring oscillator section including a current control type ring oscillator circuit. A current quantity supplied to the current control type ring oscillator circuit is determined based on the reference voltage. The reference voltage generating circuit includes a constant current source circuit connected with a power supply voltage and configured to output a reference current to an output node based on the power supply voltage; a current-voltage converting circuit connected the output node and configured to generate a reference voltage to the output node based on the reference current; a first voltage adjusting circuit connected with the output node and configured to adjust dependence of the reference voltage on the power supply voltage in a positive direction; and a second voltage adjusting circuit connected with the output node and configured to adjust dependence of the reference voltage on the power supply voltage in a negative direction.

According to the present invention, a reference voltage generating circuit capable of freely controlling dependence of a reference voltage on a power supply voltage in both positive and negative directions is provided.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a configuration diagram illustrating a conventional reference voltage generating circuit;

FIG. 2A is an explanatory diagram illustrating transistor characteristics for a case where the early effect is absent;

FIG. 2B is an explanatory diagram illustrating transistor characteristics for a case where the early effect is present;

FIG. 3 is a configuration diagram illustrating a conventional reference voltage generating circuit;

FIG. 4 is a configuration diagram illustrating a reference voltage generating circuit of a first embodiment;

FIG. 5 is a schematic diagram for explaining the dependence of a reference voltage on a power supply voltage;

FIG. 6 is a simulation result for a case where the dependence is adjusted in a negative direction;

FIG. 7 is a simulation result for a case where the dependence is adjusted in a positive direction; and

FIG. 8 is a configuration diagram illustrating a timer circuit of a second embodiment.

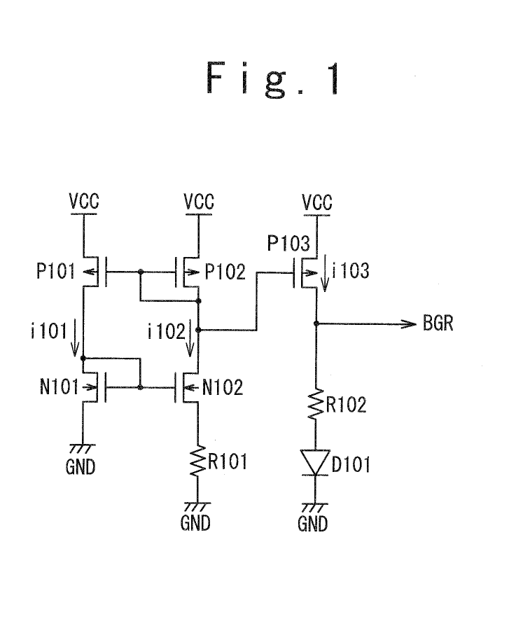

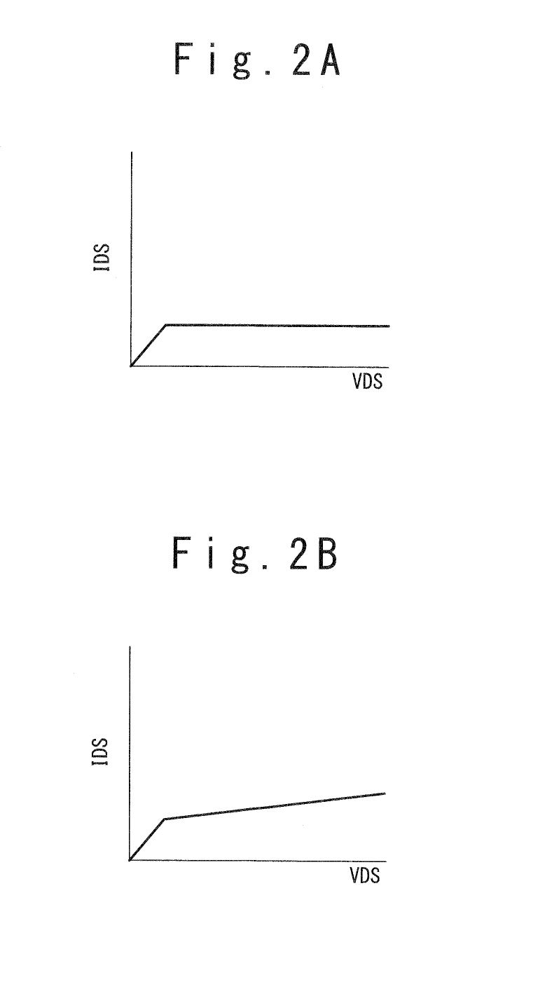

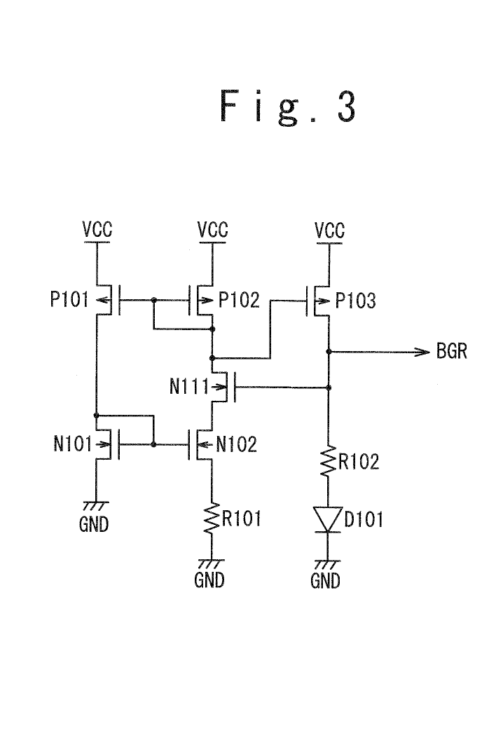

### DESCRIPTION OF THE PREFERRED EMBODIMENTS

Hereinafter, a reference voltage generating circuit of the present invention will be described in detail with reference to the attached drawings.

### First Embodiment

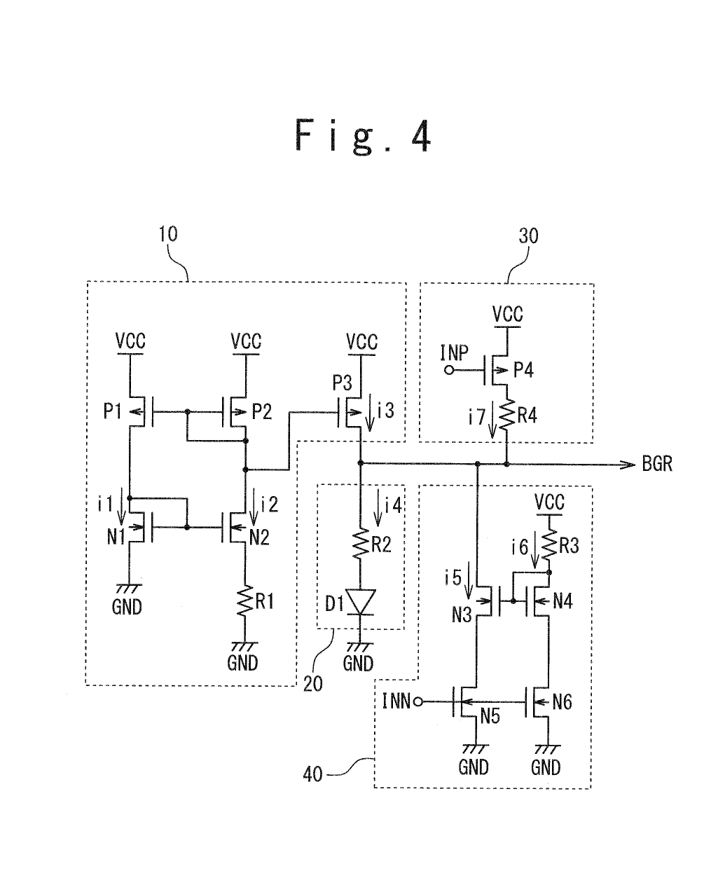

FIG. 4 is a circuit diagram illustrating a configuration of the reference voltage generating circuit according to a first embodiment of the present invention. Referring to FIG. 4, the reference voltage generating circuit includes a constant current source circuit 10, a current-voltage converting circuit 20, a first voltage adjusting circuit 30, and a second voltage adjusting circuit 40. In the reference voltage generating circuit, a voltage at an output terminal (BGR) of the constant current source circuit 10 is taken out as a reference voltage Vbgr.

The constant current source circuit 10 generates a constant reference current (i3). The constant current source circuit 10 includes PMOS transistors P1, P2, and P3, NMOS transistors N1 and N2, and resistance element R1. Each of sources of the PMOS transistors P1, P2, and P3 is connected to a power supply Vcc. Also, a gate of the PMOS transistor P1, a gate and a drain of the PMOS transistor P2, and a gate of the PMOS transistor P3 are commonly connected to one another to have the same voltage. A drain of the NMOS transistor N1 is connected to that of the PMOS transistor P1. A drain of the NMOS transistor N2 is connected to that of the PMOS transistor P2. A gate and a drain of the NMOS transistor N1 and a gate of the NMOS transistor N2 are commonly connected to have the same potential. A source of the NMOS transistor N1 is connected to the ground voltage (hereinafter GND), and grounded. A source of the NMOS transistor N2 is grounded via R1. A drain of the PMOS transistor P3 is connected to the output terminal BGR. The reference current i3 is a current flowing from the drain of the PMOS transistor P3 to the output terminal BGR side.

It should be noted that it is assumed that the PMOS transistors P1, P2, and P3 have a same gate length and a same gate width. Also it is assumed that gate lengths of the NMOS transistors N1 and N2 are same, and a gate width of the NMOS transistor N2 is M (M>0) times larger than that of the NMOS transistor

In the constant current source circuit 10 having the above-described configuration, the PMOS transistors P1 and P2 are arranged in a current mirror configuration. The NNOS transistors N1 and N2 are also arranged in a current mirror configuration. Further, the PMOS transistors P2 and P3 are arranged in a current mirror configuration, as well. Accordingly, given that a current flowing from the power supply voltage Vcc to the ground voltage GND via the PMOS transistor P1 and the NMOS transistor N1 is i1, and a current flowing from the power supply voltage Vcc to the ground voltage GND via the PMOS transistor P2, the NMOS transistor N2, and the resistance element R1 is i2, the current i2 depends on the current i1, and the reference current i3 is equal to the current i2.

Ideally, (when the early effect to be described later does not arise), in a voltage range where the power supply voltage Vcc is equal to or more than a certain voltage (voltage range where each of the transistors in the constant current source circuit operates in a weak inversion state), the reference current i3 is constant independently of the power supply voltage Vcc. However, if the power supply voltage Vcc is lower than a target voltage range, the reference current i3 depends on the power supply voltage Vcc. It should be noted that when dependence on the power supply voltage Vcc will be described below, the dependence in the range where the reference current i3 is ideally constant independently of the power supply voltage Vcc is assumed.

Subsequently, the current-voltage conversion circuit 20 will be described. The current-voltage converting circuit 20 generates the reference voltage Vbgr at the output terminal BGR. The current-voltage converting circuit 20 is provided between the output terminal BGR and the ground voltage GND. The current-voltage converting circuit 20 in the present embodiment includes a resistance element R2 and a diode element D1. One end of the resistance element R2 is connected to the output terminal BGR. The diode element D1 is connected to the other end of the resistance element R2 at an anode thereof, and grounded at a cathode thereof.

Given that, in the current-voltage converting circuit 20, a current flowing to the ground voltage GND via the resistance element R2 and the diode element D1 is i4, the reference voltage Vbgr expressed by the following equation (4) is generated at the output terminal BGR:

Vbgr=VF(D1)+i4×r2,

where VF(D1) is a forward direction voltage of the diode element D1, and r2 a resistance value of the resistance element R2.

Subsequently, the first voltage adjusting circuit 30 will be described. The first voltage adjusting circuit 30 adjusts the dependence of the reference voltage Vbgr on the power supply voltage in a positive direction.

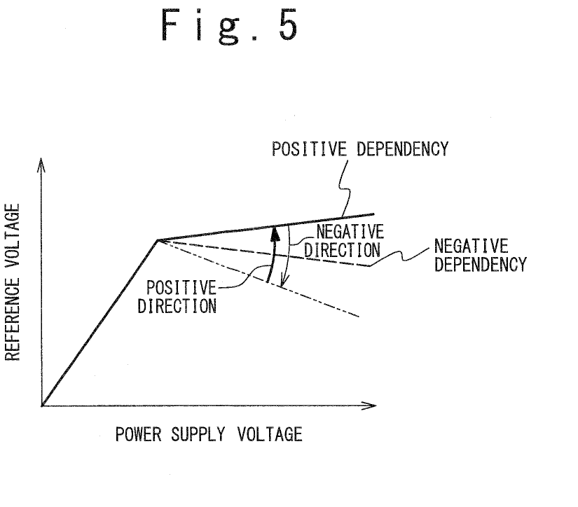

It is now assumed that the dependence of the reference voltage on the power supply voltage indicates a variation in reference voltage in case that the power supply voltage is increased by a unit voltage. FIG. 5 is a diagram schematically showing the dependence of the reference voltage on the power supply voltage. It is also assumed that the dependence of the reference voltage on the power supply voltage indicates a slope in case that a vertical axis represents the reference voltage, and a horizontal axis represents the power supply voltage. If the slope is positive, the dependence of the reference voltage on the power supply voltage is positive, whereas if the slope is negative, the dependence of the reference voltage on the power supply voltage is negative. The positive direction means a direction in which the slope is increased, whereas a negative direction means a direction in which the slope is decreased.

Referring to FIG. 4 again, the first voltage adjusting circuit 30 includes a PMOS transistor P4, and a resistance element R4. A source of the PMOS transistor P4 is connected to the power supply Vcc. Also, a drain of the PMOS transistor P4 is connected to the output terminal BGR via the resistance element R4. A gate of the PMOS transistor P4 is connected to an input terminal INP. Further, a current flowing through the PMOS transistor P4 is i7. In the first voltage adjusting circuit 30, if a low level is supplied to the input terminal INP, the PMOS transistor P4 is turned ON so that the current i7 flows. The current i7 is supplied to the current-voltage converting circuit 20. Accordingly, the current i7 is just superimposed on the current i3 to increase the current i4 supplied to the current-voltage converting circuit 20. On the other hand, if the PMOS transistor P4 is in an OFF state, i7=0, and therefore the current i4 is not affected by the current i7.

Subsequently, the second voltage adjusting circuit 40 will be described. The second voltage adjusting circuit 40 adjusts the dependence of the reference voltage Vbgr on the power supply voltage in the negative direction. The second voltage adjusting circuit 40 includes NMOS transistors N3, N4, N5, and N6, and a resistance element R3. A drain of the NMOS transistor N3 is connected to the output terminal BGR. A source of the NMOS transistor N3 is connected to a drain of the NMOS transistor N5. A source of the NMOS transistor N5 is grounded. A drain of the NMOS transistor N4 is connected to the power supply Vcc via the resistance element R3. A drain of the NMOS transistor N6 is connected to a source of the NMOS transistor N4, and a source of the NMOS transistor N6 is grounded. The drain and a gate of the NMOS transistor N4 and a gate of the NMOS transistor N3 are connected to have a same voltage. Gates of the NMOS transistors N5 and N6 are connected to an input terminal INN. Also, it is assumed that the NMOS transistors N3 and N4 have the same gate length and a same gate width.

In the second voltage adjusting circuit 40, a current flowing from the output terminal BGR side to the ground voltage GND via the NMOS transistors N3 and N5 is i5. Also, a current flowing from the power supply Vcc to the ground voltage GND via the resistance element R2, the NMOS transistors N4 and N6 is i6. In the second voltage adjusting circuit 40, if a high level is supplied to the input terminal INN, the NMOS transistor N5 and N6 are turned ON, and consequently the currents i5 and i6 flow. This shunts the reference current i3 to the second voltage adjusting circuit 40 by an amount equal to the current i5. For this reason, the current i4 supplied to the current-voltage converting circuit 20 is decreased. It should be noted that the NMOS transistors N3 and N4 are arranged in a current mirror configuration, and therefore i5=i6. On the other hand, if a low level is supplied to the input terminal INN, the NMOS transistor N5 and N6 are turned OFF, and therefore i5 and i6 do not flow. As a result, the reference current i3 is not shunted.

Subsequently, an operation of the reference voltage generating circuit in the present embodiment will be described. At first, a case that the dependence of the reference voltage Vbgr on the power supply voltage is adjusted in the negative direction will be described. It is also assumed that no early effect arises in the transistors of the reference voltage generating circuit 10.

A high level signal is supplied to the input terminals INN and INP. As a result, the PMOS transistor P4 of the first voltage adjusting circuit 30 is turned OFF, and therefore the current i7=0. On the other hand, the NMOS transistor N5 and N6 of the second voltage adjusting circuit 40 are turned ON, and therefore the currents i5 and i6 flow. As already described, the NMOS transistors N3 and N4 are arranged in a current mirror configuration, so that the current i6 flowing through the NMOS transistor N4 and that i5 flowing through the NMOS transistor N3 are equal (i5=i6) The current i6 is determined based on the power supply voltage Vcc, a resistance value r3 of the resistance R3, and a threshold voltage (VTN4) of the NMOS transistor N4, and is expressed by the following equation (5):

i6=i5=(Vcc−VTN4)/r3 (5)

From the equation (5), it can be understood that i6 (=i5) increases with increasing Vcc because VTN4 and r3 are independent of the power supply voltage Vcc.

On the other hand, as already described, the reference voltage Vbgr is determined based on the current i4 supplied to the current-voltage converting circuit 20, and is expressed by the following equation:

Vbgr=i4×r2+VFD1.

Here, i4=i3-i5, and i3=i2. Therefore, i4=i2−i6. Accordingly, the reference voltage Vbgr is expressed by the following equation (6):

Vbgr=(i2−(Vcc−VTN4)/r3)×r2+VF_{D1} (6)

In the equation (6), Vcc, VTN4, and r3 take positive values, and Vcc>VTN4. Also, ((Vcc−VTN4)/r3) takes a positive value, and is increased with increasing the power supply voltage Vcc. Accordingly, (i2−(Vcc−VTN4)/r3) is decreased with increasing the power supply voltage Vcc. As a result, the reference voltage Vbgr is decreased with increasing the power supply voltage Vcc. That is, the reference voltage Vbgr is not constant relative to the power supply voltage, but has the negative voltage dependence.

The extent to which the reference voltage Vbgr depends on the power supply voltage is determined based on the resistance value r3 of the resistance element R3. This will be described below. It should be noted that the extent to which the reference voltage Vbgr depends on the power supply voltage is referred to as a dependence amount. It is now assumed that the power supply voltage is varied from a lower voltage Vcc to a higher voltage Vcc′. If the PMOS transistors P1 and P3, and the NMOS transistor N2 have no early effect, the current i2 is constant independently of the power supply voltage, and also the threshold voltage VTN, and the resistance values r2 and r3 are constant independently of voltage, so that, from the already described equation (6), the reference voltage Vbgr′ after the variation is expressed by the following equation (7):

Vbgr′=(i2−(Vcc′−VTN4)/r3)×r2+VFD1 (7)

Accordingly, the voltage variation ΔVbgr of the reference voltage Vbgr is expressed by the following equation (8), because ΔVbgr=(Vbgr′=Vbgr),

ΔVbgr=(i2−(Vcc′−VTN4)/r3)×r2+VFD1−((i2−(Vcc−VTN4)/r3)×r2+VFD1)=−Vcc′×r2/r3+Vcc×r2/r3=−(Vcc′−Vcc)×r2/r3.

Given that, in the equation (8), (Vcc′−Vcc) is denoted by ΔVcc, a variation in power supply voltage ΔVbgr is expressed by the following equation (9):

ΔVbgr=−ΔVcc×r2/r3 (9)

From the above equation (9), it can be understood that if the resistance value r2 is constant, the variation in reference voltage ΔVbgr is decreased with the resistance value r3 increasing, whereas it is increased with the resistance value r3 decreasing. As described, by adjusting the resistance value r3 of the resistance element R3, an amount of the dependence of the reference voltage Vbgr on the power supply voltage can be adjusted in the negative direction. The resistance value can be easily changed as compared with the case where a gate width of a transistor is changed Adjustment at a manufacturing stage is not required as in case that the gate width of the transistor is changed to adjust a current amount, and therefore the resistance value adjustment is advantageous.

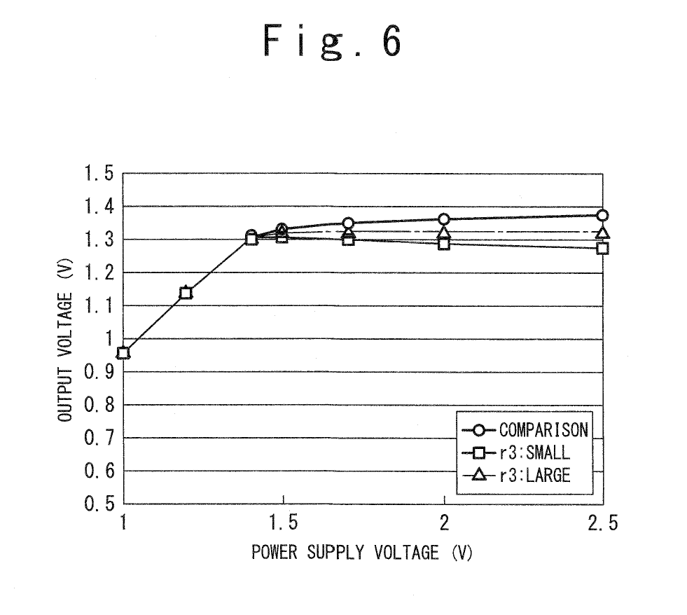

In an absence of the early effect, the dependence of the reference voltage on the power supply voltage can be adjusted in the negative direction, so that, also in a presence of the early effect, dependence of the reference voltage on the power supply voltage due to the early effect can be negated. FIG. 6 is a simulation result illustrating a relationship between the power supply voltage and the reference voltage in case that the high level is supplied to the input terminals INN and INP. In FIG. 6, a line plotted with open circles represents a result when the first voltage adjusting circuit 30 and the second voltage adjusting circuit 40 are not provided, and is shown for comparison. Also, a line plotted with open squares represents a result when the resistance value r3 in the second voltage adjusting circuit 40 is set relatively small. Further, a line plotted with open triangles represents a result when the resistance value r3 in the second voltage adjusting circuit 40 is set relatively large. As illustrated in FIG. 6, when the voltage adjusting circuits 30 and 40 are not provided, the reference voltage Vbgr is not constant due to the early effect, and exhibits the positive voltage dependence in a power supply voltage range of approximately 1.4 V or more. On the other hand, when the resistance value r3 is set relatively small, the positive voltage dependence due to the early effect is negated, and the reference voltage is constant in the power supply voltage range of approximately 1.4 V or more. Further, when resistance value r3 is set relatively large, the reference voltage is decreased with increasing the power supply voltage in the power supply voltage range of approximately 1.4 V or more. That is, an amount of the dependence of the reference voltage on the power supply voltage is larger in the negative direction than that in the case that the resistance value r3 is set relatively small.

The resistance value r3 to negate the dependence of the reference voltage due to the early effect will be described more specifically. If the PMOS transistors P1 and P3, and the NMOS transistor N2 have the early effects, the voltage dependence on the power supply voltage arises in the current i3 as already described. It is assumed that when the power supply voltage is varied from Vcc to Vcc′ by ΔVcc (=Vcc′−Vcc), the current i3 flowing through the PMOS transistor P3 is varied to i3′ by Δi3. At this time, the variation ΔVgbr in reference voltage Vbgr is expressed by the following equation (10):

ΔVgbr=(i3′−(Vcc′−VTN4)/r3)×r2+VFD1−((i3−(Vcc−VTN4)/r3)×r2+VFD1),

where if ΔVgbr=0, then the resistance value r3 is expressed by the following equation (11):

r3=ΔVcc/Δi3.

That is, if the resistance value r3 is set to a value as expressed by the equation (11), the current i5 flowing through the second voltage adjusting circuit 40 becomes equal to Δi3. Therefore, a variation in the current i4 supplied to the current-voltage converting circuit 20 becomes zero. This causes the variation ΔVbgr in the reference voltage Vbgr to be zero, and consequently the reference voltage Vbgr becomes independent of the power supply voltage.

Subsequently, a case will be described where the dependence of the reference voltage Vbgr on the power supply voltage Vcc is adjusted in the positive direction.

The low level signal is assumed to be supplied to the input terminals INP and INN. At this time, the NMOS transistors N5 and N6 are turned OFF, and therefore the current i5 does not flow. On the other hand, the PMOS transistor P4 is turned ON, and therefore the current i7 flows from the power supply Vcc to the output terminal side of the constant current source circuit 10. The current i7 is determined based on the reference voltage Vbgr, the power supply voltage Vcc, and the resistance value r4 of the resistance element R4, and expressed by the following equation (12):

i7=(Vcc−Vbgr)/r4 (12)

In this case, the current i4 supplied to the current-voltage converting circuit 20 becomes i4=i3+i7, and therefore the reference voltage Vbgr is expressed by the following equation (13):

Vbgr=(i3+i7)×r2+VF_{D1}=(i3+(Vcc−Vbgr)/r4)×r2+VF_{D1} (13)

Solving the equation 13 for Vbgr, Vbgr is expressed as the following equation (14)

Vbgr=(i3×r2+Vcc×r2/r4+VF_{D1})/(1+r2/r4) (14)

In the equation (14), Vcc, r2, and r4 take positive values. Accordingly, with increasing the power supply voltage Vcc, (Vcc×r2/r4) is increased. That is, the reference voltage Vbgr has the positive voltage dependence on the power supply voltage Vcc.

Also, in the equation (14), Vbgr is the function of (Vcc×r2/r4). Accordingly, for example, by adjusting the resistance value r4 to control the value of (r2/r4) under a constant r2 condition, the voltage dependence can be changed.

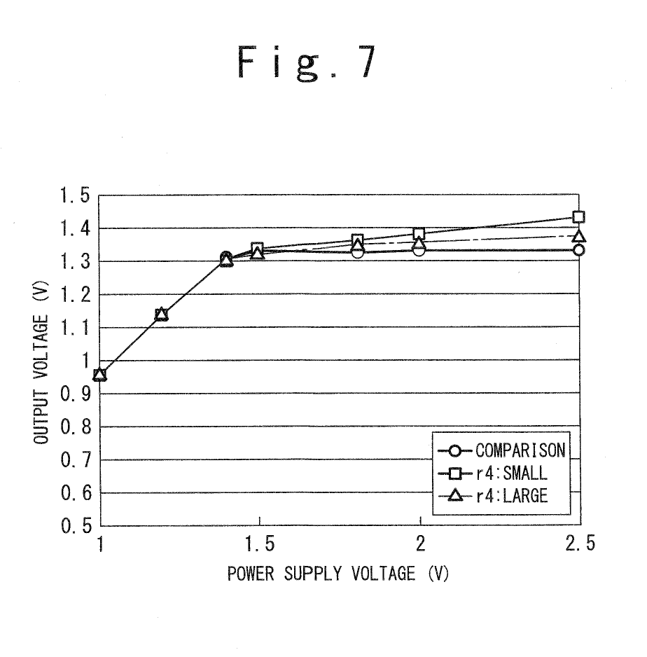

FIG. 7 illustrates a simulation result showing a relationship between the power supply voltage and the reference voltage when the low level signal is supplied to the input terminals INN and INP of the present embodiment. In FIG. 7, a line plotted with open circles represents a result when the first voltage adjusting circuit 3 and the second voltage adjusting circuit 40 are not provided, and is shown for comparison. Also, a line plotted with open squares represents a result when the resistance value r4 in the second voltage adjusting circuit 40 is set to be relatively small. Further, a line plotted with open triangles represents a result when the resistance value r4 in the second voltage adjusting circuit 40 is set to be relatively large. As illustrated in FIG. 7, as compared with a comparison case, when the resistance value r4 is set to be relatively small (plotted with the open squares), the voltage dependence in the positive direction is enhanced. Also, when the resistance value r4 is set to be relatively large (plotted with the open circles), the voltage dependence in the positive direction is further enhanced than that when the resistance value r4 is set to be relatively small. As described, by adjusting the resistance value r4 of the resistance element R4 in the first voltage adjusting circuit 30, the positive voltage dependence of the reference voltage Vbgr can be adjusted.

As described above, according to the first embodiment, by operating the first voltage adjusting circuit 30, the dependence of the reference voltage Vbgr on the power supply voltage can be adjusted in the positive direction. On the other hand, by operating the second voltage adjusting circuit 40, the dependence of the reference voltage Vbgr on the power supply voltage can be adjusted in the negative direction.

Also, according to the present embodiment, any of the first or second voltage adjusting circuit 30 or 40 can be operated by a signal inputted to the input terminals INP and INN. Accordingly, the dependence of the reference voltage on the power supply voltage can be adjusted in both of the positive and negative directions.

Further, according to the present embodiment, by adjusting the value of the resistance element R4 provided on the first voltage adjusting circuit 30, an amount of the dependence of the reference voltage Vbgr on the power supply voltage Vcc can be adjusted in the positive direction. On the other hand, by adjusting a value of the resistance element R3 provided on the second voltage adjusting circuit 40, the dependence amount can also be adjusted in the negative direction.

That is, according to the present embodiment, the dependence of the reference voltage on the power supply voltage can be freely adjusted in both of the positive and negative directions, and also an amount of the dependence can be adjusted. Accordingly, in a circuit in which the reference voltage has dependence on the power supply voltage, such as a circuit in which the early effect is present in a transistor, the dependence can also be negated to keep the reference voltage constant relative to the power supply voltage.

### Second Embodiment

Subsequently, the reference voltage generating circuit according to a second embodiment of the present invention will be described. The present embodiment shows to a case where the reference voltage circuit as described in the first embodiment is applied to a variable temperature timer circuit. The variable temperature timer circuit is used for a refresh timer for a pseudo SRAM. For a timer circuit used for such an application, a high-speed operation at high temperature, and a low-speed operation at low temperature are required. It should be noted that the period is required to be independent of a power supply voltage.

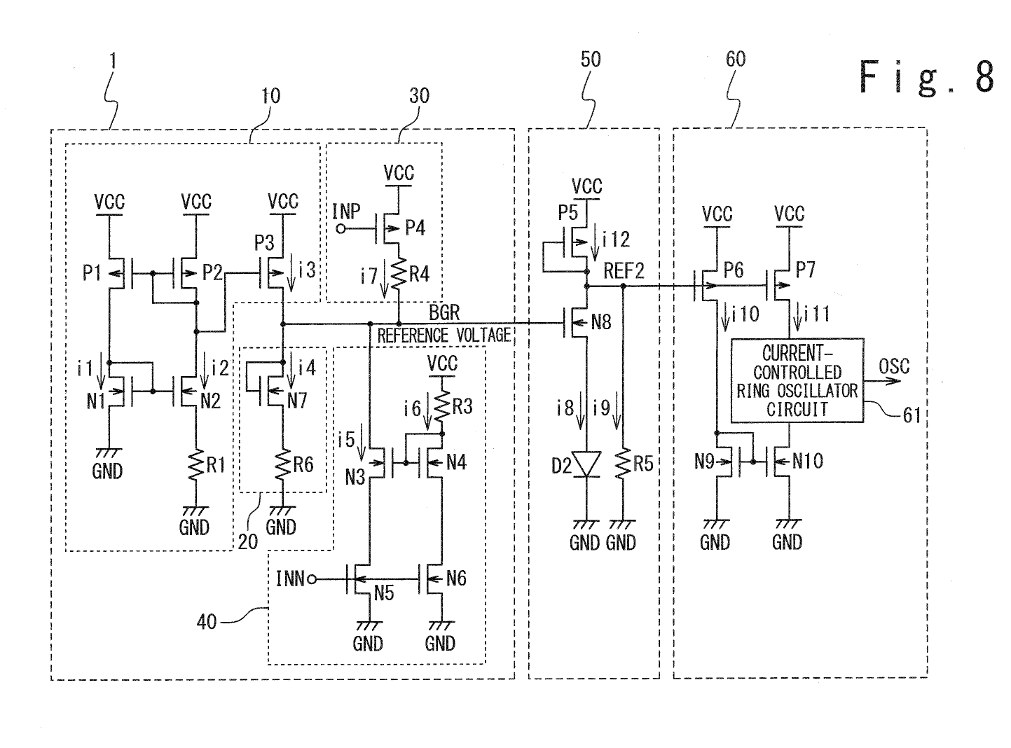

FIG. 8 is a circuit diagram illustrating a configuration of a timer circuit of the present embodiment. The timer circuit includes a reference voltage generating circuit 1, a voltage converting circuit 50, and a ring oscillator section 60.

In the reference voltage generating circuit 1 in the second embodiment, a configuration of the current-voltage converting circuit 20 is partially modified as compared with the reference voltage generating circuit in the first embodiment. The current-voltage converting circuit 20 in the second embodiment is provided with an NMOS transistor N7 and a resistance element R6, instead of the resistance element R4 and a diode element D1. A gate and a drain of the NMOS transistor N7 are connected to an output terminal of the constant current source circuit 30. Also, a source of the NMOS transistor N7 is connected to the ground voltage GND via the resistance element R6. It should be noted that a configuration of the reference voltage generating circuit 1 excluding the current-voltage converting circuit 20 is the same as that in the first embodiment, and therefore a detailed description of it is omitted.

The ring oscillator section 60 is a circuit for periodically generating a timer clock signal OSC. The ring oscillator section 60 includes PMOS transistors P6 and P7, NMOS transistors N9 and N10, and a current-controlled ring oscillator circuit 61. A source of the PMOS transistor P6 is connected to the power supply voltage Vcc, and a gate of the PMOS transistor P6 is connected to an output terminal (hereinafter to be referred to as REF2) of the voltage converting circuit 50. A source of the PMOS transistor P7 is connected to the power supply voltage Vcc, and a gate of the PMOS transistor P7 is connected to the output terminal REF2. A gate and a drain of the NMOS transistor N9 are connected to a drain of the PMOS transistor P6, and a source of the NMOS transistor N9 is connected to the ground voltage GND. A source of the NMOS transistor N10 is connected to the ground voltage GND, and a gate of the NMOS transistor N10 is connected to the gate and the drain of the NMOS transistor N9. In addition, the NMOS transistor N9 and the NMOS transistor N10 have a same gate length and a same gate width.

In the current-controlled ring oscillator circuit 61, a current flowing through the PMOS transistor P6 and the NMOS transistor N9 is i10, and a current flowing through the PMOS transistor P7 is i11.

The current-controlled ring oscillator circuit 61 generates the timer clock signal OSC with a period t_{osc} on the basis of higher and lower voltage side power supply input signals. The current-controlled ring oscillator circuit 61 is connected to a drain of the PMOS transistor P7 to receive the higher voltage side power supply input signal from the drain of the PMOS transistor P7. Further, the current-controlled ring oscillator circuit 61 is also connected to a drain of the NMOS transistor N10 to receive the lower voltage side power supply input signal from the drain of the NMOS transistor N10. The period t_{osc} is ideally determined based on the current i11 supplied from the PMOS transistor P7. As the current i11 is decreased, the period t_{osc} becomes longer, whereas as the current i11 is increased, the period t_{osc} becomes shorter.

Subsequently, the voltage converting circuit 50 will be described. The voltage converting circuit 50 is provided to change an amount of the current ill in the ring oscillator section 61 depending on temperature. A specific configuration of the voltage converting circuit 50 will be described. The voltage converting circuit 50 includes a PMOS transistor PS, a NMOS transistor N8, a diode element D2, and a resistance element R5. A source of the PMOS transistor P5 is connected to the power supply voltage Vcc, and a drain and gate of the PMOS transistor P5 is connected to the output terminal REF2. A gate of the NMOS transistor N8 is connected to the output terminal BGR, and a drain of the NMOS transistor N8 is connected to the output terminal REF2. The diode element D2 is connected to a source of the NMOS transistor N8 at an anode thereof, and to the GND voltage at a cathode thereof. The resistance element is connected to the terminal REF2 at one terminal thereof, and to the GND voltage at the other terminal thereof. In addition, a gate length of the NMOS transistor N8 is a same as that of the NMOS transistor N7 in the reference voltage generating circuit 1. Also, a gate width of the NMOS transistor N8 is a same as that of the NMOS transistor N7. Further, a gate length and a gate width of the PMOS transistor P5 are same as those of the PMOS transistor P6 and those of the PMOS transistor P7 in the ring oscillator section.

In the voltage converting circuit 50, a current flowing through the NMOS transistor N8 and the diode element D2 is i8. Also, a current flowing through the resistance element R5 is i9. Further, a current flowing through the PMOS transistor P5 is i12. Then, i12=i8 +i9. It should be noted that it is assumed that the resistance element R5 is set to a value such that the current i8 sufficiently larger than the current i9 at a high temperature.

In such a voltage converting circuit 50, the diode element D2 causes temperature dependence in a second reference voltage REF2. A forward direction voltage VDF2 of the diode element D2 is characterized in that it is small at high temperature and large at low temperature. If the reference voltage Vbgr is constant, a gate-source voltage of the NMOS transistor N8 becomes smaller at low temperature. This brings the NMOS transistor N8 close to an OFF state. As a result, the current i8 is decreased. The current i12 flowing through the PMOS transistor PS is expressed by (i8+i9). Because the current i8 is decreased, the current i12 is also decreased. The PMOS transistor PS and the PMOS transistor P7 of the ring oscillator section 61 are arranged in a mirror configuration, and therefore i12=i11. That is, if the current i12 is decreased, the current i11 is also decreased. If the current i11 is decreased, the period t_{osc} becomes longer. That is, it can be understood that as temperature is decreased, the period t_{osc} becomes longer, whereas as temperature is increased, the period t_{osc} becomes shorter.

It should be noted that, in order to obtain a desired period t_{osc} at high temperature, it is only necessary to adjust the gate-source voltage of the NMOS transistor N8 to adjust the current i8. To adjust the gate-source voltage of the NMOS transistor N8, it is only necessary to adjust the resistance element R6.

In the timer circuit having the configuration as described above, if the reference voltage Vbr is constant, a phenomenon as described below may arise to vary the period t_{osc} with respect to the power supply voltage Vcc at high temperature. If the reference voltage Vbgr is constant, the current i8 is also constant independently of the power supply voltage Vcc. On the other hand, if the power supply voltage Vcc is increased, the current i9 is also increased because a voltage difference between the both ends of the resistance element R5 is increased. However, as already described, the resistance element R5 is set to increase a ratio of the current i8 to the current i9 at high temperature, so that even if the power supply voltage Vcc is increased, an increase in the current i12 (=i11) is relatively small. Accordingly, even if the power supply voltage Vcc is increased, the current i11 flowing through the PMOS transistor P7 of the ring oscillator section 60 is almost unchanged. If the current i11 is almost unchanged, and the power supply voltage Vcc is only increased, an electric charge amount upon charging/discharging associated with an operation of the current-controlled ring oscillator is increased. This makes the period t_{osc} of the outputted timer clock signal longer. Accordingly, the period t_{osc} has the dependence on the power supply voltage, i.e., with increasing the power supply voltage Vcc, the period t_{osc} becomes longer.

In the present embodiment, the dependence of the reference voltage Vbgr on the power supply voltage can be freely adjusted in both of the positive and negative directions, as already described in the previous embodiment. Accordingly, the dependence of the reference voltage Vbgr on the power supply voltage can be adjusted to negate the dependence of the period t_{osc} on the power supply voltage.

Specifically, in the reference voltage generating circuit 1, a low level signal is supplied to the terminals INP and INN. This operates the first voltage adjusting circuit 30 to adjust the dependence of the reference voltage Vbgr on the power supply voltage in the positive direction. The resultant dependence is defined as the positive dependence. If the reference voltage Vbgr has the positive dependence on the power supply voltage, as the power supply voltage Vcc is increased, the gate-source voltage of the NMOS transistor N8 is increased and the current i8 is also increased. This increases the current i12 (=i11), and accelerates (shortens) the period t_{osc}. At this time, if the resistance value of the resistance element R4 is adjusted, an amount of the dependence of the reference voltage Vbgr on the power supply voltage can be adjusted, and therefore the dependence of the period t_{osc} on the power supply voltage at high temperature can be completely negated.

In addition, if the early effects arise in the PMOS transistors P1 and P3, and the NMOS transistor N2 in the reference voltage generating circuit 10, the positive dependence on the power supply voltage arises in Vbgr unless the first voltage adjusting circuit 30 and the second voltage adjusting circuit 40 are operated. In this case, if the power supply voltage Vcc is high, a current value i11 may be increased, and the period on the high voltage side may become too fast. In such a case, the terminals INP and INN are supplied with a high level signal to operate the second voltage adjusting circuit 40, and the resistance value of the resistance element R3 is adjusted to eliminate the dependence of the period t_{osc} on the power supply voltage. This allows the dependence of the period t_{osc} on the power supply voltage Vcc to be negated.

As described above, in the present embodiment, a timer circuit of which the period t_{osc} is independent of the power supply voltage can be obtained by applying the reference voltage generating circuit capable of freely adjusting the dependence of the reference voltage Vbgr on the power supply voltage in both of the positive and negative directions to the variable temperature timer circuit. By adjusting the dependence of the reference voltage Vbgr on the power supply voltage in this manner as required, an application range of the reference voltage generating circuit, such as a timer circuit, can be expanded.

The first and second embodiments have been described as above. However, any of them is merely embodiments of the present invention. They can be also used in combination as required. For example, the first embodiment may be configured to have the current-voltage converting circuit of the second embodiment. Also, it would be apparent to those skilled in the art that they should not be relied upon to construe the appended claims in a limiting sense.

What is claimed is:

1. A reference voltage generating circuit comprising:
a constant current source circuit connected with a power supply voltage and configured to output a reference current to an output node based on the power supply voltage;
a current-voltage converting circuit connected said output node and configured to generate a reference voltage to said output node based on the reference current;
a first voltage adjusting circuit connected with said output node and configured to adjust dependence of said reference voltage on the power supply voltage in a positive direction; and
a second voltage adjusting circuit connected with said output node and configured to adjust dependence of said reference voltage on the power supply voltage in a negative direction.

2. The reference voltage generating circuit according to claim 1, wherein said first voltage adjusting circuit is connected with said output node to supply a first current to said current-voltage converting circuit.

3. The reference voltage generating circuit according to claim 2, wherein said first voltage adjusting circuit comprises:
a first resistance element connected between said power supply voltage and said output node, and
said first current is supplied to said output node via said first resistance element.

4. The reference voltage generating circuit according to claim 1, wherein said first voltage adjusting circuit adjusts the dependence of said reference voltage on the power supply voltage in the positive direction when the reference current has dependence on the power supply voltage.

5. The reference voltage generating circuit according to claim 1, wherein said second voltage adjusting circuit is connected with said output node to shunt the second current from the reference current.

6. The reference voltage generating circuit according to claim 5, wherein said second voltage adjusting circuit comprises:
a second resistance element provided between said power supply voltage and a ground voltage, and
said second voltage adjusting circuit shunts the second current based on a current flowing through said second resistance element.

7. The reference voltage generating circuit according to claim 1, wherein said second voltage adjusting circuit adjusts the dependence of the reference voltage on the power supply voltage when the reference current has a dependence on the power supply voltage.

8 The reference voltage generating circuit according to claim 1, wherein said first voltage adjusting circuit has a first switch,
said second voltage adjusting circuit has a second switch,
said first voltage adjusting circuit adjusts the dependence of the reference voltage on the power supply voltage when said first switch is turned on, and
said second voltage adjusting circuit adjusts the dependence of the reference voltage on the power supply voltage when said second switch is turned on.

9. The reference voltage generating circuit according to claim 1, wherein said current-voltage converting circuit generates the reference voltage based on a current supplied from said constant current circuit.

10. The reference voltage generating circuit according to claim 1, wherein said current-voltage converting circuit comprises:
a third resistance element and a first diode of a forward direction which are connected in series between said output node and the ground voltage.

11. The reference voltage generating circuit according to claim 1, wherein said current-voltage converting circuit comprises:
a transistor having a drain and a gate connected with said output node; and
a fourth resistance element connected between a source of said transistor and the ground voltage.

12. A timer circuit comprising:
a reference voltage generating circuit configured to output a reference voltage; and
a ring oscillator section including a current control type ring oscillator circuit,
wherein a current quantity supplied to said current control type ring oscillator circuit is determined based on the reference voltage, and
said reference voltage generating circuit comprises:
a constant current source circuit connected with a power supply voltage and configured to output a reference current to an output node based on the power supply voltage;
a current-voltage converting circuit connected said output node and configured to generate a reference voltage to said output node based on the reference current;
a first voltage adjusting circuit connected with said output node and configured to adjust dependence of said reference voltage on the power supply voltage in a positive direction; and
a second voltage adjusting circuit connected with said output node and configured to adjust dependence of said reference voltage on the power supply voltage in a negative direction.

13. The timer circuit according to claim 12, further a second diode element,
wherein the current quantity supplied to said current control type ring oscillator circuit depends on said second diode element in addition to the reference voltage.
